(19) United States
(12) Patent Application Publication
(10) Pub. No.: US 2007/0074447 A1
(43) Pub. Date: Apr. 5, 2007

(54) Mosquito water trap

(76) Inventor: Alexander Joseph Kalogroulis, Coulsdon (GB)

Correspondence Address: Curtis L. Harrington;Suite 250, 6300 State University Drive, Long Beach, CA, 90815, US

(21) Appl. No.: 11/244,913

(22) Filed: Oct. 5, 2005

(51) Int. Cl. A01M 1/02; A01M 1/06; A01M 1/10

(52) U.S. Cl. 43/107; 43/139

(57) ABSTRACT

A trap may include structure which provides the attraction of mosquitoes to breeding water and provides a variety of destruction mechanisms, including drying, drowning, heat, and ultrasonic killing mechanism and method for larvae, and a quick suction killing mechanism and method for adult mosquitoes. Other mechanisms, ancillary structures and additional action can be employed with any of the mechanisms singly, or a pair of the mechanisms along with a double acting trap to help kill adult mosquitoes.

### FIELD OF THE INVENTION

The present invention relates to improvements in appliances which improve the living spaces for people, and more particularly to a trap for luring and killing mosquitoes and in which the efficacy is demonstrated to the user.

### BACKGROUND OF THE INVENTION

Mosquitoes have plagued humans with their bite and associated disease for centuries. Mosquitoes have recently become a focus of increasing concern because of the West Nile Virus. Although large-scale efforts have been employed to attempt to reduce populations for the public, not much has been done to try to reduce the populations which may thrive in and around habitations. Many products have tried to repel the mosquito whilst others try to lure it into a trap. Of the latter types of traps, most use forms of UV light, pheromones, carbon dioxide, water vapor and heat. Most of these active traps work only with adult mosquitoes and because they deal with the flying adult mosquito, involve some form of energy or output which is annoying to humans.

It is generally thought that the only worthwhile attractant for a mosquito is carbon dioxide. This is because a female mosquito needs a host from which to suck blood, and uses carbon dioxide to help it locate its host. However, the main reason for a mosquito to feed is to enable it to create a batch of eggs. These eggs must then be laid in water, without it, there is no effective continuation of the mosquito life cycle. The mosquito must possesses an ability to track down sources of water in which to lay their eggs, and this need can be exploited. Note that it is possible for a female mosquito to lay eggs without having consumed a blood meal, however the quantity of eggs will be low.

In many countries, the health service asks the population to empty all containers of standing water to attempt to break the life cycle by stopping egg laying and preventing new mosquitoes from developing. Covering large areas can be expensive and the elements of nature tend to blunt any attempt at controlling wide areas exposed to the sun and rain.

Even on a small scale, any trap which attracts and kills mosquitoes within a defined living space which has limited entry for mosquitoes can be highly effective in reducing or eliminating mosquito bites in humans. Further, any trap which kills mosquitoes before they can reproduce or hatch will have at least some effectiveness even in an open area.

### SUMMARY OF THE INVENTION

The trap may include structure which provides the attraction of mosquitoes to breeding water and provides a variety of destruction mechanisms. Many of the mechanisms can be used in combination with each other or singly. The trap preferably includes a seemingly stagnant pool of water, but includes both a drying, drowning, heat, and ultrasonic killing mechanism and method for larvae, and a quick suction killing mechanism and method for adult mosquitoes. Other mechanisms, ancillary structures and additional action can be employed with any of the mechanisms singly, or a pair of the mechanisms along with a double acting trap to help kill adult mosquitoes.

Female mosquitoes with fertilized eggs, as well as adult male mosquitoes are lured to the trap. Fertile females who lay eggs will either be killed before or shortly after laying their eggs have their eggs, and their offspring or eggs will be killed.

An air sweep mechanism is used to kill adult mosquitoes of both sexes. A lured male or a lured a female biting mosquito about to lay eggs will be allowed to settle at a container's edge of a and start laying its eggs. A sudden gust of air will then draw the mosquito through into an isolation chamber where it will die. An intermittent sucking or directed blowing action provides sufficient stillness to enable mosquitoes to be enticed into a position for capture. The intermittent stillness (1) eliminates fans or electrical sounds during the attraction process, (2) permits sufficient still air gradient to attract mosquitoes based upon moisture or other air borne component, and (3) assists in transmitting the moisture or other air borne component more widely.

Mosquito eggs and larvae are also independently trapped and killed. If the female manages to lay any eggs before being sucked or blown into an isolation chamber, these eggs would be either (1) killed in solution, (2) allowed to hatch and then either suffocate or drown. Suffocation can be accomplished by not allowing the hatching mosquito access to enough air to live. Drowning can be accomplished by providing no upper surface through which the mosquito can dry out and begin to breathe.

In addition, other agents can be used, especially those which are not perceptible to adult mosquitoes, such as surfactants which either cause the adult to become wetted and drown and/or which will not allow the larvae to dry sufficiently to enable them to breathe above water. Further, other killing agents can be introduced. Chemical agents can be introduced to attack the larvae. The chemical agent can be restricted to a lower area through use of a higher density gel or other segregatory mechanism. The larvae usually develop at or near the bottom of standing water. Any segregated chemical agent would not be apparent to the egg laying adult, but the larvae would come into contact with the chemical at the bottom of the water volume. Methods to insure segregation include the bonding of the harmful chemical component to a polymer which would remain segregated from the water's upper volume and surface.

Another possibility is a biological agent which infects or feeds on the mosquito larvae. Such a system contemplates an agent that can itself survive long periods in an aquatic environment. Such a system can be used in combination with the swept air capture method in order to kill adult mosquitoes and prevent further laying. Drying is yet another technique. If the larvae are hatched to the wriggling stage, they can be physically removed from the aquatic environment by use of a mechanical system which can range from a conveyer belt to a rotating drum and more. Physical removal will ultimately cause drying of the larvae which will cause death.

The simplest realization for the invention, which enables the simplest mechanism as a turning action, includes a hemispherical bowl about 500 mm diameter. The bowl is be divided into about six compartments with removable radial walls that are meshed and or slotted to allow the free flow of water but small enough to trap and filter mosquito larvae. The container is preferably mounted on an angled axis so that when the bowl is filled with water, only half the compartments contain water, while the other half are above water and dry. This compartmental sieve is then made to rotate extremely slowly so as to achieve one turn about every eight days. Turning can be accomplished by using an intermittent solenoid to advance the rotation by ratchet action, a geared-down mechanism, or similar. Even absent any other actions or the presence of other chemicals, surfactants or agents, any eggs laid in the water section will be wet for up to four days, only long enough to hatch into wriggling larvae.

As the sieve rotates, each compartment slowly leaves the water, crowding and concentrating any larvae present into an ever decreasing volume until the small volume of larvae is finally removed from the water. The larvae then dry out over the next four days.

Above this main container, the isolation chamber would be preferably mounted. The isolation chamber would be prefaced by a suction mechanism such as a venturi, a fan with a fast acting motor, or bellows. The isolation chamber would serve as a repository for anything sucked up or blown into the isolation chamber. The cover of the isolation chamber is also of hemispherical in shape to direct the air and entrained mosquitoes.

Further, structures can be utilized to further shade the liquid in the container, or to, catch any rainwater or hose pipe water and divert it into the bowl. In this instance, a spillway would be available to prevent overfilling. The structure can also house any electronics utilized to control the turning of the subdivided filter. Temperature sensors can control the rate of turn depending upon ambient temperature, turning slightly faster during hot, arid conditions, and slower in cooler wetter conditions. An optional lens material in the upper housing can be used both to focus ambient light into the dry portion of the chambers, as well as to give an expanded look at its contents.

Power source can include housing alternating current mains, or batteries or a transformer connection to the alternating current mains for greater flexibility. Because of the low energy usage, the unit could be operated using solar cells. However the best position for the trap would be in the shade (where mosquitoes typically seek a volume of water that will last long enough to hatch their brood. Any solar panel would preferably be an auxiliary solar panel located remotely from the trap, such as on a raised post.

Maintenance involves only occasional topping up of water and flushing out of the bowl, if required at all. If the water evaporates, the aquatic side of the trap will become ineffective until the next filling. Period washing of the mesh partitions may be preferably although given the time of operation, only if the dividers were completely clogged with a water impermeable matter would the larvae fail to drain and dry. If the trap is placed within an automatic irrigation zone then it could be left to operate without maintenance at the beginning of each season.

The exterior of the trap housing could be made in a variety of fanciful shapes and sizes. The shapes could be made to match the inside decor, or made of fanciful shapes for the outer living areas. Evaporation of water can be mitigated by additional reservoirs and automated replenishment systems.

### BRIEF DESCRIPTION OF THE DRAWINGS

The invention, its configuration, construction, and operation will be best further described in the following detailed description, taken in conjunction with the accompanying drawings in which:

FIG. 1 is a side sectional view of a first embodiment of the trap of the invention, combining a turning sieve and over mounted with an air capture system;

FIG. 2 is a front view, taken along line 2-2 of FIG. 1 and illustrating the components and their availability to the exterior of the trap;

FIG. 3 is a side sectional view of a second embodiment of the trap of the invention, combining a turning over housing having a capture housing balanced opposite a laying chamber, with a fan mounted at the center; and

FIG. 4 is a top view of the trap seen in FIG. 3 or similar and illustrates a cover and expanded photo electric cell placement for extended periods of unattended service.

### DETAILED DESCRIPTION OF THE PREFERRED EMBODIMENT

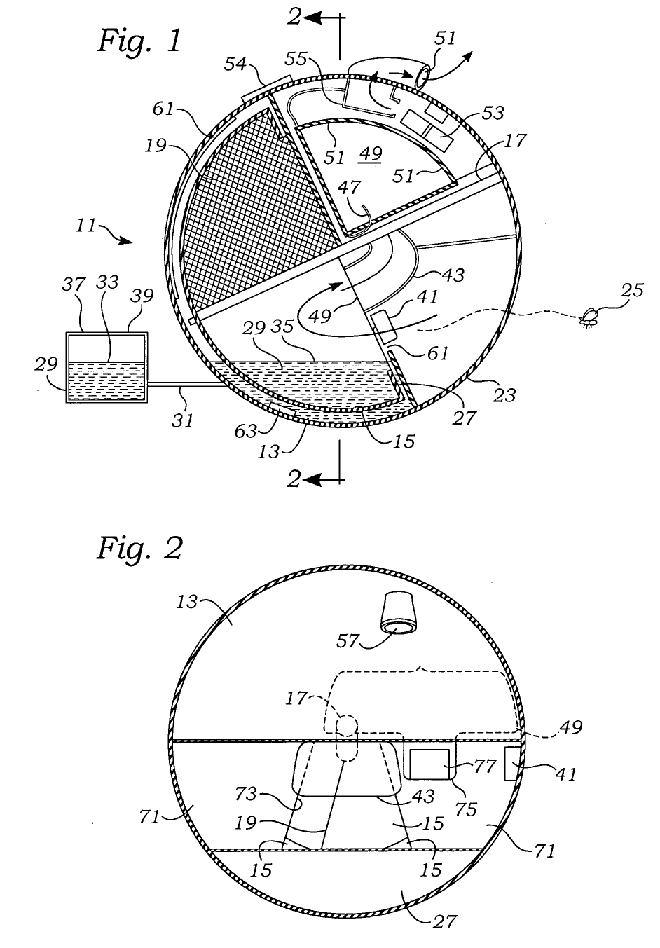

The first embodiment of the invention illustrates the principle of killing larvae by drying, and a description is best begun with reference to FIG. 1. In the drying method, any mosquito egg rafts which are laid in a defined volume of water are automatically filtered out slowly over time to kill any larvae present by drying. The overall geometry of a trap 11 illustrated is spherical, but any geometry which permits energy efficient turning is acceptable. A housing 13 supports a bowl which is hemispherically shaped. The bowl 15 is supported on a shaft 17 and is motorized slowly to rotate about the shaft 17 every few days. The bowl 15 is divided into segments by a series of mesh or screen 19 walls which permit water to move freely from segment to segment, but which will hold all solid matter larger than the screen within the segment.

As the bowl 15 turns over a period of days, any mosquito larvae within a small body of water 21 at the bottom of the tilted bowl will have been raised out of the body of water 21, drained and then slowly pass over the shaft 17 for a sufficiently long time that death will result. After death, the larval body may simply be cycled back into the body of water 21. An opening 23 is large enough to admit mosquitoes 25, especially seeking to lay eggs int he body of water 21. The opening 23 may be large enough to admit birds who might feed upon the mosquito carrion, and any other biological material which might be present.

Even though the mechanism is shown as a bowl 15 having a tilted rotational axis, other geometries are possible for affecting the main objective, namely that the larvae are lifted from a volume of water and then dried. Another important preferred aspect of any geometry is that mosquitoes should not have any access to any part of the water volume which cannot be filtered.

A close fitting lip 27 is shown, extending horizontally across the bottom of the opening 23 to prevent significant “mosquito access” exposure of any part of the surface of the body of water 21 which is not subject to having its contents filtered. In other words, the mosquito 25 should be prevented from laying eggs in the body of water 21 which lies outside the filtration action of the screen 19. In the drawing shown, this may be accomplished by supporting the body of water 21 wholly within the bowl 15 or by providing an expanded body of water 21. Where the body of water 21 is isolated within the bowl 15, it can more easily become depleted via evaporation. Further, even where the screen 19 is made of hydrophobic material, and even where the bowl 15 turns slowly to enable the surface tension of the water time to withdraw to itself, the mass being strained may still likely act to remove significant of material which in turn carries significant amounts of water with it. This will create more evaporation than simply the water entrained within the bodies being filtered. This can be even more severe where other structures are provided to ensure that evaporation is had more quickly as by heating (by light absorption) and venting.

The key to providing a constant and adequate liquid level in simple terms is the provision of an expanded supply. A reservoir 29 is connected though a tube 31 in communication through the housing 13. Where a gravity system is used, a water level 33 in the reservoir 29 will be at the same level as a water level 35 within the housing 13. As can be seen, the close fitting lip 27 serves as an upper limit to the level of the water level 35. In fact, it can serve as a spillway should the reservoir 29 be overfilled, or should the reservoir 29 or some other structure be utilized to catch rain water and re-charge both the water level 35 inside the trap 13 and the water level 33 inside the reservoir.

Preferably, the structures beneath the close fitting lip 27 will not collect any spillage and will not provide any structure or opportunity for larvae to develop. Further, the reservoir 29 preferably has a cover 37 fitted with some opening, either an aperture 39 or some fritted glass filter or screen to enable displacement air to enter the reservoir 29 without enabling mosquitoes to lay eggs within the reservoir 29.

A motor 41 is mounted preferably so as to remain above the water level and to advance the rotation of the bowl 15 very slowly about the shaft 17. The motor 41 can be a stepper motor or a geared continuous motor. In the case where motor 41 is a stepper motor and where the bowl 15 is fitted with 1080 teeth, for example, a rotation of once per eight days would equal the activation of one ratchet gear about every 10 minutes. A fractional second upset movement of ⅓ of a degree followed by 10 minutes of stillness would not provide a significant upset to adult mosquitoes seeking the body of water 21.

Over the opening 23, are located other structures with due accommodation for the shaft 17 and other structures. An inlet duct 43 has an open end 45 closely adjacent the forward edge of bowl 15. This is for the purpose of close placement, but without blocking the rotation of the bowl 15. The duct 43 leads through a flexible flap opening 47 and into a main capture chamber 49. The main capture chamber 49 includes a mesh surface 51 in fluid communication with an impulse fan 53. The inlet of the impulse fan 53 is located adjacent the mesh surface 51 so that the inlet can draw air through the mesh surface 51 over a wide area. An exhaust duct 55 leads to an exhaust port 57 which is preferably arranged to cover and protect against the inlet of moisture.

Both the motor 41 and the fan 53 may preferably be powered either wholly or partially by photo electric cells 54 mounted to receive light impinging upon the housing 13. Power storage can be by re-chargeable battery or by capacitor. Because of the size of the trap 11, a series of series and parallel connected capacitors can be utilized to store energy from solar cells and yet discharge the energy at a higher voltage.

The manner in which the impulse fan 53 is triggered may be one or a combination many methods. A timer may be used to trigger the fan 53 at intermittent times. A microprocessor may accept inputs from the solar cell 54 in order to gauge the hours of daylight and dark and adjust the timing of triggering based upon the time of day or surrounding ambient conditions in which it is expected that more mosquitoes may be present.

Other sensors can be employed, including sound, motion, and ambient light interference, as well as motion on the surface of the water level 35. An absolute time difference between triggerings of the fan 53 could be used to prevent excessive triggering or to prevent triggering should an initiating component become fouled or broken. The program can change based upon a different hierarchy of inputs for each set of conditions or temporal onset of conditions.

In the configuration shown in FIG. 1, a mosquito 25 which enters the opening 23 and alights on the surface 35 of the body of water 21 may be sucked into the open end 45 of the inlet duct 43 and be deposited within the main capture chamber 49. The overall shape of the inlet duct 43 may be preferably dictated by the overall configuration and pathways within a trap 11. It is preferable to create an air path which will easily gain momentum quickly and which will reduce obstructionist flow paths which would interfere with good facilitated flow of the mosquito 25 into the capture chamber 49.

It is reminded that FIG. 1 is shown in sectional view and that the bowl 15 can be subdivided either broadly or narrowly to determine the effective width of space between two adjacent screens 19 which will face the open end 45 of the inlet duct 43. The bowl 15 could range between having three divider screens 19 and up to 18 divider screens 19. A larger number of divider screens 19 reduces the effective width between the screens 19. The degree of fineness and thickness of the screen 19 material will determine the degree to which flowing air will bleed into spaces between adjacent screens. Since the turning of the bowl 15 occurs so slowly, having a thick or fine mesh screen 19 will not be an impediment to drainage. Assuming that the material of the screen is sufficiently hydrophobic, even a thick screen 19 should not entrain any water. An upper retaining wall 59 is seen, which may be somewhat continuous with a restrictive side wall 61 which is only partially seen in FIG. 1 due to the section line of view.

The number of spaces between the screens 19, or the total width opening of the body of water 21 will ideally be limited so that a smaller amount of energy will be required to produce a given velocity of air. On average, where the radial aperture or width of the open space or open end 45 (if the same size) is the same as the space between adjacent ones of the screens 19, two of the spaces will be open at any given time. As a result, the air flow needed should be computed based both upon the effective open area, as well as the flow which will occur when a divider screen 19 is near the center of an effective open space.

As an alternative to level gravitational flow between the reservoir 29 and the inside of the housing 13, a flow restrictor could be placed between the reservoir 29 and the opening of the tube 31 into the housing 13. The restrictor should be chosen with due consideration for water purity, fouling and the growth of algae and other fouling components. A micro valve or other device may foul. In the alternative, a wicking device could be used. In a further alternative, a device could be set to admit additional water based upon the turning progress of the bowl 15.

At the rear of the trap 11 is seen an optional light transmissive transparent section 61 for admitting light into the housing 13 and to heat the bowl 15. Where the bowl 15 is made of transparent material, light will have the possibility of directly impinging any debris or mass within the upper part of the bowl 15. Where a user has the chance to place the trap 11 in a sunny area, a more rapid and complete heating will lead to a more severe drying. The presence of a body of water 21, coupled with the lack of openness of the bowl 15 will promote some re-capture of the leaving moisture by condensation.

An optional piezoelectric transducer 63 is seen in communication with the body of water 21. Transducer 63 will typcially utilize a significant amount of energy and may not be energy compatible for long periods of unattended service without either an energy storage device of significant capacity or not without powered connection to an alternating current mains. Optional piezoelectric transducer 63 is used to turn the body of water 21 into an ultrasonic bath, to kill all mosquito larvae present.

Referring to FIG. 2, a frontal view of the trap 11 from a lower perspective looking up, better illustrates the presence of restrictive side walls 71 which form an angular opening 73, through which is seen bowl 15 and one of the radially extending screens 15. Shaft 17 is seen in dashed line format and angling downwardly into the bowl 15. As can be seen, the inlet duct 43 occupies about half of the effective opening of the bowl 15 between the restrictive side walls 71. A single screen 19 divider is seen to illustrate a typical position of the bowl 19. Where the opening 73 is set to same size as the width of the space between two screens 19, there will on average be two such interspaces available at the opening 73 at any given time except when the space between the two screens 19 is perfectly aligned with the opening 73.

This geometry, and any others employed will set the necessary cross section of the duct 43 and the volume of air needed to sweep the available chamber. A narrower opening 73 will require less air flow to achieve the same velocity, but will require more divider screens 19. Also shown in FIG. 2, a lower extent 75 of the main capture chamber 49 is provided so that the user has greater ease of access to the open portion of the trap 11. A drawer 77 is provided so that users can empty the contents of the main capture chamber. Note also that because of the restrictive side walls 71 and the fairly close tolerancing of the space between the bowl 15, along with a special compartment for the motor 41, in effect seals the chambers between the screen 19 dividers when they are not in at least partial view of the angular opening 73. The opens the possibility that in addition to drying, the rate of turn of the bowl 15 could be such that any newly hatched mosquitoes die from lack of nutrients before the chamber again presents itself at the angular opening.

As has been seen, the structures employed in the trap 11 of FIGS. 1 and 2 include suction capture of adult mosquitoes, water removal from and drying of larvae, and isolation and possible starvation of any larvae which might be able to hatch before drying.

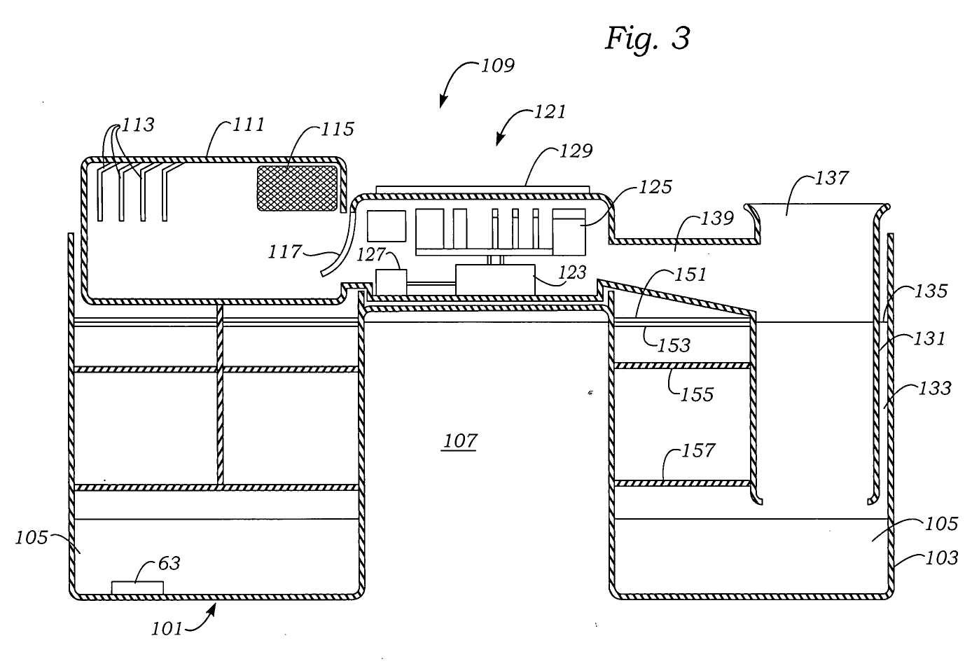

Referring to FIG. 3, a trap 101 is designed to provide suction capture of adult mosquitoes, and isolation and drowning of developing larvae. Trap 101 includes a container 103 having a series of dividers 105 surrounding an optional center support 107 for supporting an over housing 109. Beginning at the left side of FIG. 3, over housing 109 preferably includes a capture chamber 111 which may be constructed of hollow plastic with a series of filtration slots 113. In the alternative, a mesh screen 115 may be provided. In either event, the filtration slots 113 and the mesh screen 115 is provided in sufficient number or area to enable a blast of air to be forced into and escape from the capture chamber, while entraining any adult mosquitoes 25. Further, the design of the capture chamber 111 should be such that it will continue to function even when significant numbers of mosquitoes 25 are present. An optional flexible capture flap 117 is shown which will spring open as air is being forced into the capture chamber 111 and will naturally close when the flow of air stops so that the mosquitoes 25 do not escape.

The over housing 109 preferably has a center motor support portion 121 which will preferably house a motor 123 connected to a fan 125 and which may be optionally connected to a stepper motor 127 which may engage a ratchet or gear face supported by the top of the optional center support 107. A stepper motor will enable the over housing 109 to slowly rotate on the optional center support 107. Where no center support 107 is present, other structures can be utilized to cause the over housing 109 to turn. An optional solar cell 129 may be provided either on the center motor support portion 121 or other extended areas to derive power from solar light.

At the right side of FIG. 3, over housing 109 includes an isolation cup 131 is shown extending down into a volume of water 133 having a top surface 135. The top surface 135 is also seen inside the cup's laying chamber 137. In air communication with the laying chamber 137 is an airway section 139 leading to the area of the center motor support portion 121 and the fan 125.

The geometry seen in FIG. 3 combines the adult insect capture mechanism with larvae isolation. Regardless of the position of the over housing 109, any adults which alight on the top surface 135 of the volume of water 133 within the capture chamber is subject to being sucked through the airway section 139 by the motor 123 and fan 125, and into the capture housing 111. As before, the triggering event for activating the adult mosquito capture, of periodic trigger of the motor 123 can include the same triggers as was the case for impulse fan 53.

As was the case for trap 11, trap 101 must isolate the top surface 135 which is not within the boundary of the isolation cup 101 to prevent untrammeled competitive access of the top surface outside of the isolation cup 101 to both laying and the alighting of mosquitoes 25 because they cannot be captured in those areas and larvae would hatch, develop and leave normally. Isolation of the top surface 135 can be achieved by either providing a close fit cover to enclose and overlie all areas not within the isolation cup 131, or by providing a layer of material which is lighter than water but which blocks access to the water, or by providing a surfactant over areas outside of the isolation cup 131 so that any mosquitoes which alight will become wetted and drown.

A surfactant will also act to kill larvae which hatch and attempt to escape the surface. A combination of all three methods may be preferred as some surfactants may lose effectiveness over time, some overlying materials may be lost through evaporation, and providing too close of a fit with an over layer may prevent the turning of the over housing 109.

Assuming that some over coverage can be achieved, either chemically or by providing an over layer, mosquito eggs deposited in the isolation cup 131 before being drawn into the capture housing 111 will fall into spaces between the radially arranged dividers 105. Where the over housing 109 can be made to turn slowly, perhaps one revolution per 20-25 days, the larvae will develop and rise to the top surface 135 outside of the isolation cup 131. The areas of the top surface 135 outside the isolation cup 131 will be preferably covered completely either mechanically or chemically, and the mosquitoes cannot escape. It is preferable for any physical barrier to lie at or below the top surface 135 to insure drowning and to help prevent evaporation. A series of mechanical layers may be employed.

Shown are a series of optional thin plastic layers including an upper layer 151, a second layer 153, a third layer 155 and a fourth layer 157. The use of multiple layers 151, 153, 155 and 157 could be used for enhanced structural integrity. The layers 151, 153, 155 and 157 could also be arranged to trap any rising larvae at the time of hatching. One or more vertically extending members 159 could be used between the layers 151, 153, 155 and 157 for stability. As can be seen, an optional piezoelectric transducer 63 is also present, as was the case for trap 11.

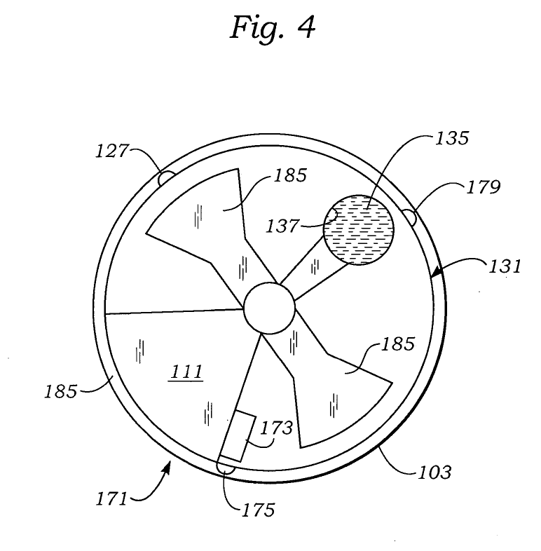

It is possible also to combine the selection of materials and components of the over housing 109 so that it floats atop the top surface 135. Referring to FIG. 4, a top view of such a configuration is seen as a trap 171. The container 103 is the same as for trap 101. A stepper motor 173 is arranged to depend from the capture housing 111 and includes a protruding drive wheel 175 which engages the inside wall of the container 103. A pair of other contact wheels 177 and 179 form a triangular arrangement with protruding drive wheel 175.

The gap seen between an outer extent of an over housing 181 and the inside wall of the container 103 is exaggerated to show the interaction of the contact wheels, with the inside wall of the container 103. The other structures seen in FIG. 4 are generally identical to those seen in FIG. 3, and may be provided as a laying chamber 137, airway section 139, and at least the upper layer 151. The trap 171 provides an isolated top surface 135 of accessible water, and an expanded area solar cell 185. In the configuration shown, the container 103 can be provided as a deep container and the trap 171 can operate for an extended period of time. As water evaporates in a limited manner from the laying chamber 137, the over housing 181 will become lowered within the container 103.

The advantages of this configuration are (1) an almost frictionless relationship between the over housing 181 and the water and/or container 103 will enable movement to be accomplished with an extremely small no energy input, (2) the surface area of water available for evaporation is small, and (3) the trap 171 can operate for extended periods with no maintenance. Again, an automatic or external provision can be made to replenish the volume of water 133. In the configuration seen in FIG. 4, the container 103 cannot be overfilled, and any excess water would simply pour over the side of the container 103 or be directed away using an upper drain. A funnel type rain collector could be used in conjunction with a directed spill off structure to provide continued operations for an almost indefinite period.

While the present invention has been described in terms of a mosquito trap, & more particularly to a multi active mosquito trap which traps and kills adults and larvae using a variety of combinational methods and physical configurations, the mechanisms disclosed can be applied to other devices.

Although the invention has been derived with reference to particular illustrative embodiments thereof, many changes and modifications of the invention may become apparent to those skilled in the art without departing from the spirit and scope of the invention. Therefore, included within the patent warranted hereon are all such changes and modifications as may reasonably and properly be included within the scope of this contribution to the art.

What is claimed:

1. A mosquito trap comprising:
a reservoir having a water volume having a water surface available to flying mosquitoes;
a filtration structure for filtering said water surface and at least part of said water volume to lift and separate insect larvae from said water volume having said water surface to dry said insect larvae; and
motive means, attached to said filtration structure, for automatically lifting at least one filtration structure.

2. The mosquito trap as recited in claim 1 and further including a suction system for suctioning and capturing mosquitoes from a position adjacent said water surface.

3. The mosquito trap as recited in claim 2 wherein said for suctioning system includes an inlet duct, a fan housing having an inlet in fluid communication with said inlet duct and an outlet, and a capture housing in fluid communication with said outliet of said fan housing, to permit passage of flowing air while trapping mosquitoes entering into the capture housing.

4. The mosquito trap as recited in claim 1 wherein said motive means is also for for automatically replacing said at least one filtration structure back into said at least part of said water volume a sufficient time after said insect larvae has had an opportunity to dry sufficiently to kill said insect larvae.

5. The mosquito trap as recited in claim 1 and further comprising a piezoelectric member in energization contact with said water volume.

6. A mosquito trap comprising:
a reservoir having a water volume having an exposed water surface available to flying insects;
a series of barriers in said reservoir over which said exposed water surface available to flying isects may move sufficiently slowly that any larvae developing will have at least one of no access and restricted access to said exposed water surface available to flying insects at the time of emerging maturity; and
motive means, attached to structure associated with said exposed water surface available to flying insects, to move availablility of said said exposed water surface available to flying insects over said series of barriers.

7. The mosquito trap as recited in claim 6 and further including a suction system for suctioning and capturing mosquitoes from a position adjacent said water surface.

8. The mosquito trap as recited in claim 6 wherein said larvae at emerging maturity are trapped in a space at the time of emergence and die.

9. The mosquito trap as recited in claim 6 wherein said larvae at emerging maturity are trapped under water at the time of emergence and die.

10. The mosquito trap as recited in claim 6 wherein said for suctioning system includes an inlet duct, a fan housing having an inlet in fluid communication with said inlet duct and an outlet, and a capture housing in fluid communication with said outliet of said fan housing, to permit passage of flowing air while trapping mosquitoes entering into the capture housing.

11. The mosquito trap as recited in claim 10 wherein said inlet duct is adjacent said water volume having an exposed water surface available to flying insects.

12. The mosquito trap as recited in claim 6 and further comprising a piezoelectric member in energization contact with said water volume.
